(19) United States
(12) Patent Application Publication
(10) Pub. No.: US 2014/0301223 A1
(43) Pub. Date: Oct. 9, 2014

(54) ESTIMATION OF DELAY PROBABILITY AND SKEW TIME OF DATA PACKET TRANSMITTED OVER A COMMUNICATION NETWORK

(71) Applicants: Shin Horng Wong, Swindon (GB); Thang Pham, Montreal (CA); Vikas Dhingra, Bangalore (IN)

(72) Inventors: Shin Horng Wong, Swindon (GB); Thang Pham, Montreal (CA); Vikas Dhingra, Bangalore (IN)

(73) Assignee: ALCATEL LUCENT, Paris (FR)

(21) Appl. No.: 14/238,544

(22) PCT Filed: Jul. 4, 2012
(86) PCT No.: PCT/EP2012/063016

§ 371 Date: Jun. 19, 2014

(30) Foreign Application Priority Data
Aug. 12, 2011 (IN) 2305/DEL/2011

(51) Int. Cl. H04L 12/26

(52) U.S. Cl. CPC H04L 43/0852
USPC 370/252

(57) ABSTRACT

The present subject matter discloses systems and methods for data transfer in communication networks. In one implementation, the method comprises determining a skew time based in part on a maximum skew time of the communication network and a probability of a data packet being delayed during transmission over the communication network. The method further includes detecting at least one missing data packet transmission and initiating retransmission of the at least one missing data packet after a time interval exceeding the determined skew time.

### FIELD OF INVENTION

The present subject matter relates to communication networks and, particularly but not exclusively, to data transfer in communication networks.

### BACKGROUND

Communication devices, such as mobile phones, personal digital assistants, portable computers, provide users with a variety of wireless communications services and computer networking capabilities. These communications services allow data, for example, documents, to be exchanged between the users. Universal Mobile Telecommunications System (UMTS), developed and maintained by the 3GPP (3rd Generation Partnership Project), is a third generation mobile communication technology for communication networks based on the Global System for Mobile Communication (GSM) standards. UMTS employs wideband code division multiple access (W-CDMA) radio access technology to offer greater spectral efficiency and higher bandwidth to mobile network operators. In “Performance Analysis of Handoff Techniques Based on Mobile IP, TCP-Migrate and SIP”, published in IEEE Transactions on Mobile Computing, vol. 8, no. 7, July 2007, pages 731 to 747, five different classes of mobile applications are described and analytical models for investigating the handoff performance of the existing mobility management protocols for these application classes are presented.

Release 5 of the 3GPP standards specified High Speed Packet Access (HSPA), as a part of the enhancements of the communication networks, so as to enhance the user experience of the services provided through the communication networks and to cater to a larger number of users. In accordance with the 3GPP standards, the HSPA specifies two protocols—High Speed Downlink Packet Access (HSDPA) and High Speed Uplink Packet Access (HSUPA). HSDPA is based on techniques such as adaptive modulation, and hybrid automatic repeat requests (HARQ) and provides high throughput, high peak powers and efficient utilization of the resources of the network and is supported by two downlink channels namely the High-Speed Downlink Shared Channel (HS-DSCH) and the High-Speed Shared Control Channel (HS-SCCH) and an uplink High-Speed Dedicated Physical Control Channel (HS-DPCCH).

However, with the large number of user availing various services provided by the communication networks, such as HSPA mobile communication networks, the HSPA mobile communication networks are faced with issues related to capacity saturation, inadequate cell edge performance, etc. Further, in HSPA mobile communication networks, adjacent sectors and frequency carriers are often unevenly loaded, due to which the full capacity of the HSPA mobile communication network could not be achieved.

Release 8 of the 3GPP standards depicted new standards for the communication networks, namely the Dual-Cell HSDPA which is also referred to as Dual-Carrier HSPA (or in short DC-HSDPA). DC-HSDPA attempts to achieve better resource utilization and spectrum efficiency of the communication network by means of joint resource allocation and load balancing across the downlink carriers.

The new standards of 3GPP defined two distinct categories of data transfer between a communication network and a communication device. In a first category, referred to as the Multi Cell HSDPA (MC-HSDPA), the communication device receives data from two carriers at the same time from a single Node B of the communication network. The single Node B utilizes two different carrier frequencies to transmit the data to the communication device. The concepts of DC-HSDPA have been further enhanced to enable the communication device to receive data from four carriers (4C-HSDPA), or eight carriers (8C-HSDPA). In a second category, referred to as Multi Point HSDPA (MP-HSDPA), the communication device receives data from two carriers simultaneously from two different Node Bs of the communication network. In such a case, the two Node Bs may transmit data using the same or different carrier frequencies.

### SUMMARY

This summary is provided to introduce concepts related to data transfer in communication networks. This summary is neither intended to identify essential features of the claimed subject matter nor is it intended for use in determining or limiting the scope of the claimed subject matter.

In an embodiment, a method includes determining a skew time based in part on a maximum skew time of the communication network and a probability of a data packet being delayed during transmission over the communication network. The method further includes detecting at least one missing data packet transmission and initiating retransmission of the at least one missing data packet after a time interval exceeding the determined skew time.

In accordance with another embodiment of the present subject matter, a user equipment (UE) for data transfer in the communication network includes a UE skew time computation module configured to determine a skew time based in part on a maximum skew time of a communication network and a probability of a data packet being delayed during transmission and a data packet receiver module configured to identify at least one gap in the sequence of received data packets, the gap resulting because of at least one missing data packet. The user equipment further includes a UE timer module configured to generate a request for retransmission of at least one missing data packet on exceeding the determined skew time.

In accordance with another embodiment of the present subject matter, a computer readable medium having a set of computer readable instructions that, when executed, perform acts including obtaining at least one of a maximum skew time of a communication network and a probability of a data packet being delayed during transmission over the communication network and determining a skew time based in part on the maximum skew time of the communication network and the probability of the data packet being delayed during transmission.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1(a) illustrates a system for data transfer in wireless communication networks in a communication network environment, in accordance with an embodiment of the present subject matter.

FIG. 1(b) illustrates the system for data transfer in wireless communication networks in a communication network environment, in accordance with another embodiment of the present subject matter.

FIG. 2 (a) illustrates the components of the system for data transfer in wireless communication networks in a communication network environment, in accordance to an embodiment of the present subject matter.

FIG. 2 (b) illustrated an exemplary data flow diagram, in accordance with an embodiment of the present subject matter.

FIG. 3 (a) illustrates an exemplary method for data transfer in a communication network, in accordance with an embodiment of the present subject matter.

FIG. 3 (b) illustrates an exemplary method for data transfer in a communication network, in accordance with another embodiment of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DESCRIPTION OF EMBODIMENTS

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

Systems and methods for data transfer in wireless communication networks are described. The systems and methods can be implemented in a variety of communication devices or communication network devices or both the communication devices and the communication network devices. The communication devices that can implement the described method(s) include, but are not limited to, mobile phones, hand-held devices, laptops or other portable computers, personal digital assistants (PDAs), notebooks, tablets, network access adaptors and the like. Additionally, the method can be implemented in any of the wireless communication networks, such as Global System for Mobile Communication (GSM) network, Universal Mobile Telecommunications System (UMTS) network and Wideband Code Division Multiple Access (W-CDMA) network. Although the description herein is with reference to certain networks, the systems and methods may be implemented in other networks and devices, albeit with a few variations, as will be understood by a person skilled in the art.

Conventionally in Multi Cell High Speed Downlink Packet Access (MC-HSDPA), or in Multi Point High Speed Downlink Packet Access (MP-HSDPA), the communication devices, i.e., user equipments, usually communicate with one or more Node Bs using a primary carrier signal and one or more secondary carrier signals. The primary carrier transmits various control channel messages between the user equipment and the Node Bs, and hence cannot be deactivated. However, any one or more secondary carriers may be deactivated by the Node B, for example by using a High Speed Shared Control Channel (HS-SCCH) order. It should be noted that the primary carrier and the one or more secondary carriers may be from the same Node B or different Node Bs.

If the user equipment is communicating with two different Node Bs, a radio network controller (RNC) splits the data to be transferred to the user equipment between the two Node Bs. In UMTS radio access network (UTRAN) the RNC controls and monitors the Node Bs that are connected to the RNC. The RNC is also configured to manage the resources of the mobile communication network, and is generally communicatively coupled to the circuit switched core network through media gateway (MGW) and to the serving GPRS support node (SGSN).

Generally, the RNC may be configured to split the data to be transferred to the user equipment at the radio link control (RLC) layer, or at the packet data convergence protocol (PDCP) layer. The present subject matter, as per one embodiment, is described considering that the data is split at the RLC layer. It should be appreciated by those skilled in the art that the present subject matter includes within its scope, instances where the data is split at the PDCP layer.

In one example, say the RNC splits the RLC protocol data unit (PDU) into data packets in any sequence and assigns a sequence number (SN) to each data packet indicative of the order of data packets in the RLC PDU. The RNC may split the RLC PDU in any sequence. In said example, say the RNC splits the RLC PDU into eight data packets having sequence number 1, 2, 3, 4, 5, 6, 7, 8. In one implementation, the RNC can send the data packets having sequence number 1, 2, 3, 4 to a first Node B and the data packets having sequence number 5, 6, 7, 8 to a second Node B. In another implementation, the RNC can send the data packets having sequence number 1, 3 4, 7, 8 to the first Node B and the data packets having sequence number 2, 5, 6 to the second Node B.

Further, it is possible that the first Node B and the second Node B transmits the data packets at different speeds to the user equipment. For example, the first Node B transmits data packets at a faster rate than the second Node B. Hence, all the data packets would not be received by the user equipment at the same instant of time or in the same sequence as transmitted by the RNC to the two Node Bs. On receiving a data packet, the user equipment arranges the received packets from both the Node Bs in the order indicated by the sequence number. Thus the user equipment would also be aware that of the data packets which have not yet been received and hence are missing. However, the user equipment is not sure whether the data packet which is missing is lost during the transmission or whether the data packet is yet to arrive from a Node B, say the second Node B which is transmitting at a slower rate. Moreover, the user equipment is not aware of the Node B from which the missing data packets are to be received.

Moreover, in case the user equipment does not receive a data packet, the user equipment usually sends a request to the RNC through the Node B to retransmit the data packet which was not received. The retransmission of the data packet which was not received may be done through the same or a different Node B. For example, if initially the data packet having sequence number 5 was transmitted using the first Node B, the RNC may decide to retransmit the data packet having sequence number 5 using the second Node B based on various network parameters such as poor quality of radio link of the first node as indicated by a channel quality index (CQI). Thus in this case, if the user equipment requests for a retransmission of a missing data packet, which is actually not lost, but is not received at the user equipment because of the slow data transfer rate of any of the Node Bs, the user equipment would unnecessarily increase the traffic and use the resources of the communication network. On the other hand, if the user equipment waits for receiving a missing data packet, which is actually lost, the user equipment would decrease the throughput, i.e. the rate of successful transmission of data packets, of the communication network. The above mentioned scenario is also referred to as the skew problem.

The skew problem may also occur at the RNC. In this situation, the RNC keeps a track of all the data packets acknowledged to have been received by the user equipment, for example, by an acknowledgement (ACK) signal. In case the RNC does not receive the ACK signal for a data packet, the RNC fails to receive an indication of whether said data packet is lost during transmission or is not yet received by the user equipment due to low data transfer rate of any of the Node Bs. Thus the RNC is unable to decide on whether to retransmit said data packet and consume resources of the communication network or wait for the ACK signal to arrive for said data packet and decrease the throughput of the communication network.

A conventional technique to solve the skew problem involves triggering a timer circuit in the user equipment whenever a data packet is found to be missing. For a pre-defined time interval, specified by the timer circuit, the user equipment does not request retransmission of the missing data packet. On expiry of the timer, if said data packet is still not received, the user equipment would request for retransmission of said data packet. However, in said technique, it is very difficult to set the pre-defined time interval. If the pre-defined time interval is set to a high value, the user equipment might wait for a long time to receive said data packet which might be actually lost. On the other hand, if the pre-defined time interval is set to a low value, the user equipment might request retransmission of said data packet whereas said data packet might actually be in transmission and not lost during transmission.

In another conventional approach, a technique similar to the above technique is implemented at the RNC. This technique is based on the fact that the RNC is aware of the Node B through which a data packet having a particular sequence number was sent. In said technique, say the data packets having sequence number 1, 3, 5, 7 are sent through the first Node B and the data packets having sequence number 2, 4, 6, 8 are sent through the second Node B. In one example, the sequence of arrival of the data packets at the user equipment may be the data packets having sequence number 1, 3, 2, 6. Thus the user equipment determines that the data packets having sequence number 4, 5, 7 and 8 are missing. The RNC is also aware that the ACK signal for the data packets having sequence number 4, 5, 7 and 8 have not been received. However, the RNC is aware that the sequence number of the last acknowledged data packet, hence forth referred to as LSN, for the first Node B is 3 and the LSN of the data packet for the second Node B is 6. The RNC is configured to deem a data packet which has a sequence number higher than the LSN for a particular Node B as delayed during transmission (skewed) and a data packet which has a sequence number lower than the LSN for a particular Node B as lost. Thus in the above case, the data packets having sequence number 5, 7 and 8 would be deemed as delayed during transmission and the data packet having sequence number 4 would be deemed as lost during transmission. Whenever, a data packet is deemed to be delayed by the RNC, the RNC would start a timer circuit having a pre-defined time interval. On the expiry of the timer, if the ACK signal for the data packet deemed to be delayed is still not received, the RNC would initiate the retransmission of the data packet deemed to be delayed. However, this conventional technique requires the user equipment to repeatedly send status information signals to the RNC, thus increasing network traffic. The technique also increases the processing power consumed at the user equipment to transmit the status information signals and also the processing power consumed at the RNC to process the status information signals.

The present subject matter discloses methods and systems for data transfer in wireless communication networks. The systems and methods of the present subject matter may be implemented either at the RNC or at the user equipment or at both the RNC and the user equipment. In one embodiment of the present subject matter, the method for data transfer in wireless communication networks includes determining a probability of a data packet being delayed during transmission.

In one example, the user equipment is configured to determine a maximum value of the time interval, i.e., T_{MAX}_{_{—}}_{UE}_{_{—}}_{SKEW}, for which the user equipment should wait before sending a request for retransmission of a missing data packet. In another implementation the RNC is configured to determine a maximum value of the time interval, represented as T_{MAX}_{_{—}}_{RNC}_{_{—}}_{SKEW}, for which the RNC should wait for receiving the ACK signal for a data packet before deeming said data packet to be lost during transmission. The two maximum values of time interval are interchangeably referred to as T_{MAX}_{_{—}}_{SKEW}. In one implementation, the value of T_{MAX}_{_{—}}_{SKEW} is based on various network parameters such as condition of the radio channel expected at a particular cell covered by a Node B. As mentioned earlier, the method further comprises determining the probability of a data packet being delayed during transmission, henceforth referred to as the P_{SKEW}, based on various parameters, such as the signal to noise and interference ratio (SNIR), strength of the signal, channel quality index (CQI).

Based on the T_{MAX}_{_{—}}_{SKEW} and the P_{SKEW}, the time interval for which the RNC should wait before deeming a data packet, for which ACK signal has not been received, as lost and initiating the retransmission of said data packet, is determined. This time interval is indicated as T_{RNC}_{_{—}}_{SKEW}. Alternatively, the time interval for which the user equipment should wait for a missing data packet before deeming said data packet as lost and requesting a retransmission of said data packet may also be based on the T_{MAX}_{_{—}}_{SKEW} and the P_{SKEW} and is indicated by T_{UE}_{_{—}}_{SKEW}. The T_{RNC}_{_{—}}_{SKEW} and the T_{UE}_{_{—}}_{SKEW} are interchangeably referred to as the T_{SKEW}. For example, any technique explained with reference to T_{SKEW} would be applicable for both the T_{RNC}_{_{—}}_{SKEW} and the T_{UE}_{_{—}}_{SKEW} unless explicitly stated otherwise. In one implementation, the T_{SKEW} is determined based on equation 1.

T_{SKEW}=F(P_{SKEW})×T_{MAX}_{_{—}}_{SKEW}+K (Equation 1)

In equation 1, F (P_{SKEW}) denotes any function of P_{SKEW}, and K denotes any constant value. The function F may be any mathematical function based on P_{SKEW} such as linear, polynomial. The constant K may be any constant defined by the network service provider based on various parameters of the communication network.

In case a data packet has not been acknowledged by the user equipment, the RNC, instead of waiting for the T_{MAX}_{_{—}}_{SKEW}, would wait for a time interval indicated by T_{SKEW} before initializing the retransmission of said data packet. Alternatively, the user equipment would wait for a time interval as indicated by T_{SKEW} instead of T_{MAX}_{_{—}}_{SKEW} before deeming a missing data packet as lost during transmission and requesting retransmission of said data packet. Thus, the method of the present subject matter dynamically changes the time interval for which the RNC or the user equipment should wait before deeming a data packet to be lost during transmission. Hence, the RNC or the user equipment may not have to wait for the T_{MAX}_{_{—}}_{SKEW} before the process of retransmission of a missing data packet or request for retransmission of a missing data packet is initiated. This increases the throughput and reduces delay of the communication network.

For example, if the network parameters are good, the P_{SKEW} would indicate that the probability of a data packet being lost would be less. In the above scenario, any missing data packet or missing ACK signal for a data packet would be understood as delayed during the transmission. Hence, the process of retransmission of a missing data packet or request for retransmission of a missing data packet would be initiated after waiting for a longer time, i.e. for the duration of the T_{MAX}_{_{—}}_{SKEW}, and thus the resources of the communication network would not be wasted.

However, if the network parameters are poor, the P_{SKEW} would indicate that the probability of a data packet being lost would be high. In the above scenario, any missing data packet or missing ACK signal for a data packet would be interpreted as that said data packet has been lost. Hence, the process of retransmission of a missing data packet or request for retransmission of a missing data packet would be initiated after waiting for a shorter interval of time, and thus the throughput of the communication network would not be compromised. Thus the methods of data transfer of the communication network optimizes the data transfer from the RNC to the user equipment by optimizing the transmission parameters, such as the T_{SKEW}, based on which a data packet is deemed as lost during transmission or delayed during transmission.

The above methods and system are further described in conjunction with the following figures. It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “connected” is used throughout for clarity of the description and can include either a direct connection or an indirect connection.

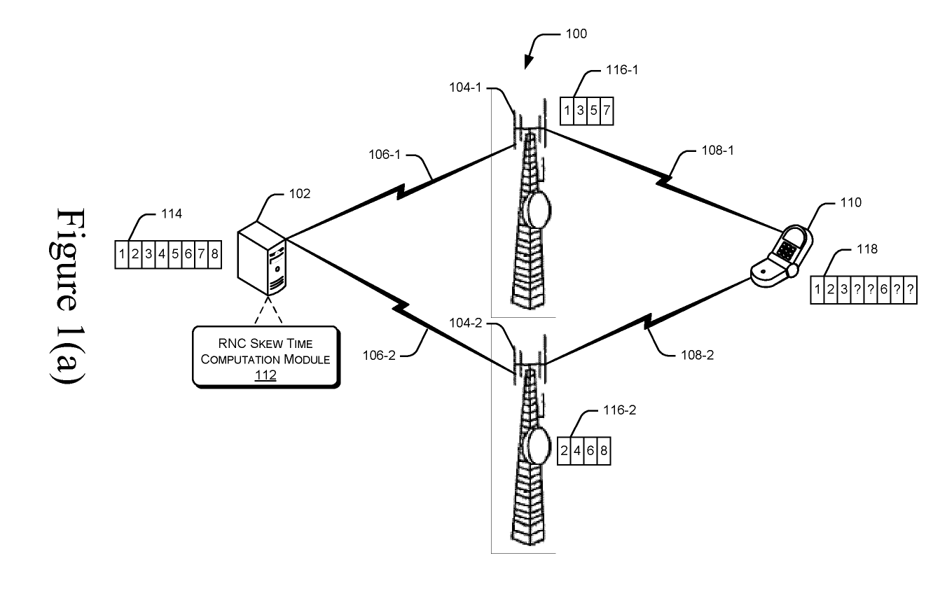

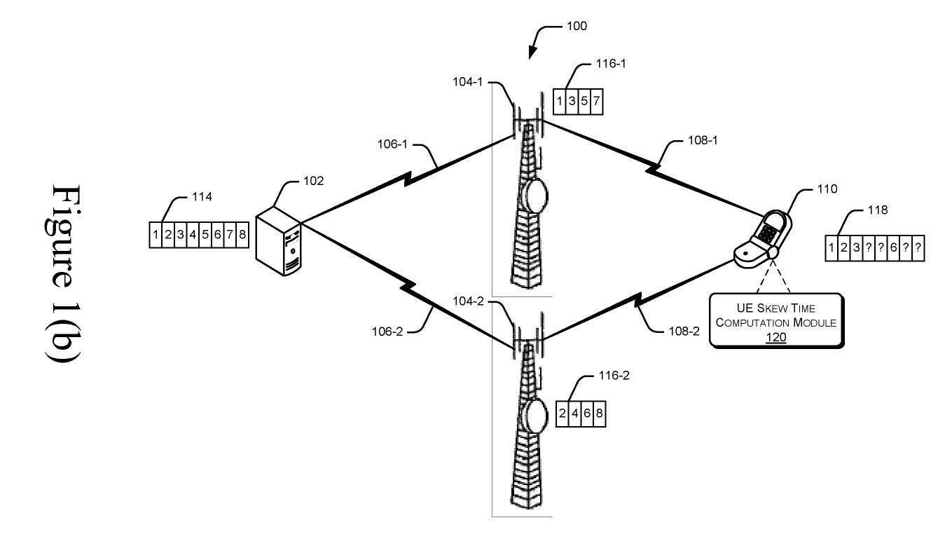

FIG. 1(a) illustrates a system 100 for data transfer in wireless communication networks in a communication network environment, in accordance with an embodiment of the present subject matter. In one embodiment, the system includes a radio network controller 102, henceforth referred to as the RNC 102, configured to manage one or more Node Bs, such as the Node Bs 104-1 and 104-2. The RNC 102 controls and communicates with the Node Bs 104-1 and 104-2 using communication links, such as communication link 106-1 and 106-2. Further the RNC 102 may be implemented as a network server, a server, a workstation, a mainframe computer, and the like. In one implementation, the RNC 102 is configured to control the Node Bs 104 connected to the RNC 102. The RNC 102 may be further configured to manage resources of the communication network and coordinate data transfer through the Node Bs 104.

The Node Bs 104 communicate via radio channels, such as radio channels 108-1, 108-2, with various user equipments, such as user equipment (UE) 110. The UE 110 may include communication devices, such as a mobile phone, a laptop computer, a desktop computer, a notebook, a smart phone, a personal digital assistant, a network adapter, a data card, a radio receiver unit. In one implementation, the RNC 102 includes a RNC skew time computation module 112, henceforth referred to as the RNCSTCM 112, configured to compute a RNC skew time indicative of the time interval for which the RNC 102 would wait for a data packet to be successfully received by the UE 110 before initiating the retransmission of said data packet to the UE 110. In one implementation, the RNCSTCM 112 is configured to determine the RNC skew time based on a maximum skew time indicated by a service provider of the communication network and a probability index indicative of the probability of a data packet being delayed, i.e., skewed during transmission. The determination of the RNC skew time is described in greater detail later in the description.

In operation, say data 114 is to be transferred from the RNC 102 through the Node Bs 104 to the UE 110. In one implementation, the data 114 may be split into a number of packets, say, eight packets. In said implementation, the RNC 102 may be configured to divide the eight data packets among the two Node Bs 104-1 and 104-2 either randomly or based on various splitting parameters, such as quality of the radio channels 108 provided by the Node Bs 104, and the computational load at the Node Bs 104. Each of the data packets is assigned a sequence number (SN) as indicated by the numerals 1, 2, 3, 4, 5, 6, 7, and 8 in the block representing the data 114. The sequence number on the blocks depicting the data 114 indicates the order in which the data packets have to be arranged so as to recreate the data 114. For example, the RNC 102 may determine the data packets with sequence numbers 1, 3, 5, and 7 to be transmitted through the Node B 104-1, as is indicated by block 116-1 and the data packets with sequence numbers 2, 4, 6, and 8 to be transmitted through the Node B 104-2 as is illustrated by block 116-2. It will be appreciated by those skilled in the art, that the radio channels 108-1 and 108-2 provided by the Node Bs 104-1 and 104-2 may be same or different in terms of channel quality as indicated by a channel quality index (CQI), rate of data transfer, signal strength and so on. Hence, the sequence in which the UE 110 would receive the data packets may be different from the sequence in which the RNC 102 transmitted the data packets to the Node Bs 104-1 and 104-2. The UE 110 is configured to transmit status information signals indicative of whether a data packet is received or is missing at the UE 110.

In certain cases, the status information signals received by the RNC 102 may indicate that there is a gap in the sequence of data packets received by the UE 110 due to one or more missing data packets. The gap in the sequence data packets is usually caused due to loss of one or more data packets during transmission or due to delay in transmission of one or more data packets. For example, the order in which the data packets are received by the UE 110 may be the data packets having the sequence numbers 1, 3, 2, and 6. The UE 110 arranges the received data packets in the order of the sequence number as is shown in block 118. In the above example, the UE 110 determines that there is a gap in the sequence of received data packets due to missing data packets, i.e., the data packets having sequence number 4, 5, 7 and 8. As mentioned earlier, the UE 110 transmits status information signals to the RNC 102 informing about the gap in the sequence of the received data packets.

In said embodiment, on receiving the status information from the UE 110, the RNCSTCM 112 initiates a timer. On the timer exceeding the RNC skew time, the RNC 102 initiates retransmission of the missing data packets. Since the RNC skew time is dependent on the probability index, the RNC skew time changes dynamically with changing conditions or network parameters of the communication network. For example, the RNC skew time may be low when the conditions of the radio channels 108 are good and may be high when the conditions of the radio channels 108 are poor. Thus the RNC 102 may not always have to wait for the maximum skew time to expire before initiating the retransmission of the missing data packets thus decreasing the delay in transmission of the data packets and increasing throughput of the communication network. On the other hand, the RNC 102 may not initiate the retransmission of the missing data packets frequently, if the conditions of the radio channels 108 are good, and thus does not unnecessarily consume and waste the resources of the communication network.

FIG. 1(b) shows the system 100 for data transfer in wireless communication networks in a communication network environment, in accordance with another embodiment of the present subject matter, wherein the above described concepts are implemented in the UE 110. In said embodiment, the UE 110 includes a UE skew time computation module 120, henceforth referred to as the UESTCM 120, configured to compute a UE skew time indicative of the time interval for which the UE 110 would wait for a data packet to be successfully received before generating a request for the retransmission of said data packet to the RNC 102. In one implementation, the UESTCM 120 is configured to determine the UE skew time, referred to as the T_{UE}_{_{—}}_{SKEW}, based on a maximum skew time indicated by a service provider of the communication network and a probability index indicative of the probability of a data packet being delayed, i.e., skewed, during transmission. The determination of the UE skew time is described in greater detail later in the description.

In operation, as mentioned earlier, say the data 114 is being received by the UE 110 from the RNC 102 through the Node Bs 104-1 and 104-2. As mentioned earlier, the data 114 may be split into a number, say eight packets, and each data packet is assigned a sequence number (SN), say numerals 1, 2, 3, 4, 5, 6, 7, and 8 in the block representing the data 114. The sequence number 114 indicates the order in which the data packets have to be arranged so as to recreate the data 114. It will be appreciated by those skilled in the art, that the radio channels 108-1 and 108-2 provided by the Node Bs 104-1 and 104-2 may be same or different in terms of channel quality as indicated by a channel quality index (CQI), rate of data transfer, signal strength and so on. Hence, the sequence in which the UE 110 would receive the data packets may be different from the sequence in which the RNC 102 transmits the data packets to the Node Bs 104-1 and 104-2. Thus, there might be a gap in the sequence in which the UE 110 receives the data packets. The gap is usually caused due to loss of one or more data packets during transmission or due to delay in transmission of one or more data packets. The UE 110 arranges the received data packets in the order of the sequence number as is shown in block 118 and determines that there is a gap in the sequence of received data packets due to missing data packets, i.e., the data packets having sequence number 4, 5, 7 and 8.

On determining the gap in the sequence of the received data packets, the UESTCM 120 initiates a timer. On the timer exceeding the UE skew time, the UE 110 may be configured to generate a request for the retransmission of the missing data packets. Since the UE skew time is dependent on the probability index, the UE skew time changes dynamically with changing conditions or network parameters of the communication network. Thus the UE 110 may not always have to wait for the maximum skew time to expire before generating a request for the retransmission of the missing data packets thus decreasing the delay in transmission of the data packets and increasing throughput of the communication network. On the other hand, the UE 110 may not generate requests for the retransmission of the missing data packets frequently, if the conditions of the radio channels 108 are good, and thus does not unnecessarily consume and waste the resources of the communication network. It would be appreciated by those skilled in the art, that the basis of determining the RNC skew time and the UE skew time are the same, however, the implementations for determining the RNC skew time and the UE skew time may vary. Further, it is also possible, that in one embodiment of the system 100, both the RNCSTCM 112 and the UESTCM 120 are present in the RNC 102 and the UE 110, respectively.

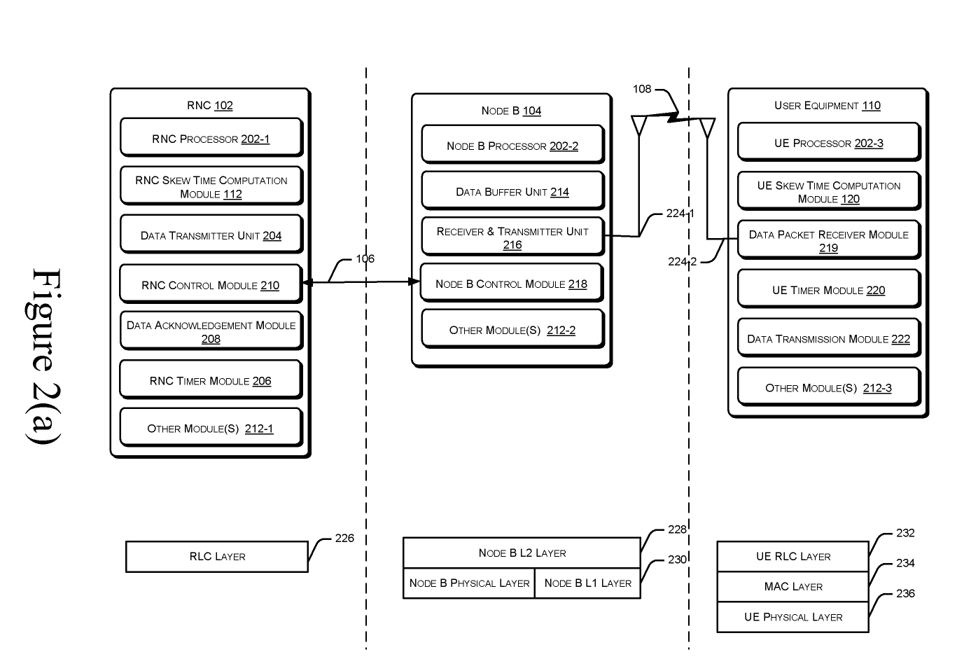

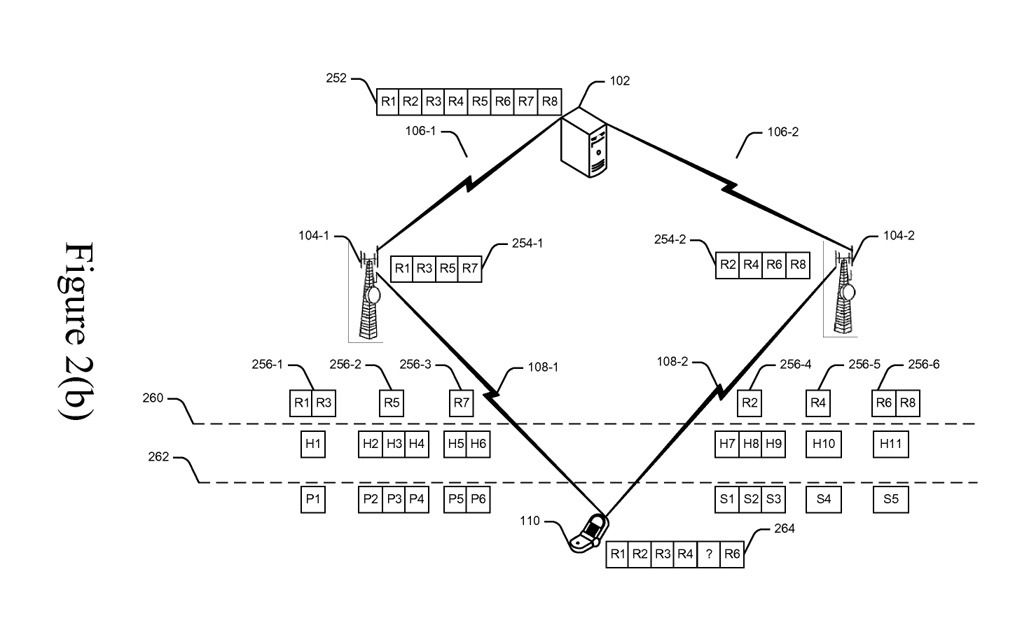

FIG. 2 (a) illustrates the components of the exemplary system 100, in accordance to an embodiment of the present subject matter. As mentioned earlier, in one implementation the system 100 includes the RNC 102, the Node Bs 104-1 and 104-2, and the UE 110. The Node Bs 104 may be understood to be structurally and functionally similar to the Node Bs 104-1 and 104-2, that and may collectively be referred to as the Node Bs 104. In said implementation, the RNC 102 includes a RNC processor 202-1, the Node B 104 includes a Node B processor 202-2 and the UE 110 includes a UE processor 202-3. The processors 202-1, 202-2 and 202-3 are collectively referred to as the processors 202.

The processor(s) 202 may include microprocessors, microcomputers, microcontrollers, digital signal processors, central processing units, state machines, logic circuitries and/or any other devices that manipulate signals and data based on operational instructions. The processor(s) 202 can be a single processing unit or a number of units, all of which could also include multiple computing units. Among other capabilities, the processor(s) 202 are configured to fetch and execute computer-readable instructions stored in one or more computer readable mediums.

Functions of the various elements shown in the figure, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

The computer readable medium may include any computer-readable medium known in the art including, for example, volatile memory, such as random access memory (RAM) and/or non-volatile memory, such as flash.

In one implementation, the RNC 102 includes various modules such as the RNCSTCM 112, a data transmitter unit 204, a RNC timer module 206, a data acknowledgement module 208, a RNC control module 210 and other modules 212-1. In said implementation, the Node B 104 includes a data buffer unit 214, a receiver and transmitter unit 216, a Node B control module 218 and other modules 212-2. The UE 110 includes he UESTCM 120, a data packet receiver module 219, a UE timer module 220, a data transmission module 222 and other modules 212-3.

The various modules described herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. Further the functionalities of various modules may be embodied directly in hardware, in a software module executed by a processor, or in a combination of the two.

In operation, the data transmitter unit 204 of the RNC 102 is configured to break or split the data 114 to be transmitted to the UE 110 into a specified number of data packets based on various splitting parameters such as the capacity of the radio channels 108, capacity of the data buffer unit 214. The data packets are transferred to the respective Node Bs 104 so as to be transmitted to the UE 110. It should be appreciated that even though the concepts of data transfer have been explained in the context of two Node Bs, the same concepts may be extended to cover any number of Node Bs with little or no modifications, as will be understood by those skilled in the art. The transmission of the data packet to the respective Node B 104 is controlled by the RNC control module 210. In one implementation, the RNC control module 210 is further configured to control and coordinate the operations of the Node B 104. For example, the RNC control module 210 may be configured to manage various functionalities facilitated through the Node B 104 such as mobility management, radio channel link management, call processing and handover mechanisms.

The RNC control module 210 may be further configured to function as the point of convergence for traffic accumulation, conversion, intelligent cell and packet processing, and coordinate hard and soft handoffs. The RNC control module 210 transmits the data packets to the Node B control module 218. The Node B control module 218 may be configured to manage the priority of transmissions of data packets and coordinates communication with the UE 110. Based on the assigned priority the data packets received by the Node B control module 218 are placed in the data buffer unit 214. In one implementation, the data packet can be placed in the data buffer unit 214 for a per-specified maximum time interval, T_{Discarded}. In one implementation, the Node B control module 218 removes a data packet from the data buffer unit 214 if the data packet under consideration is stored in the data buffer unit 214 for a time period exceeding T_{Discarded}. The data packets which are removed by the Node B control module 218 are regarded as lost during transmission.

The data packets stored in the data buffer unit 214 are transmitted to the UE 110 by a receiver and transmitter unit 216, henceforth referred to as the RTU 216. The RTU 216 is configured to perform requisite modulation and related operations so as to transmit the data packets thorough an antenna 224-1. The data packets are received by an antenna 224-2 of the UE 110. Once received, the data packet receiver module 219 may be configured to arrange the received data packets in order of the sequence number of the data packets. In one implementation, the data packet receiver module 219 may be further configured to detect a gap in the order of the received data packets caused by one or more data packets. As mentioned earlier, the gap in the order of the received data packets may be caused by a data packet which is delayed during transmission or is lost during transmission.

On detecting a gap in the order of the received data packets, the data packet receiver module 219 triggers the UE timer module 220. The UE timer module 220 waits for a time interval, denoted by T_{UE}_{_{—}}_{SKEW}, before triggering the data transmission module 222 to generate a request for retransmission of the missing data packet. For example, on the UE Timer module 220 exceeding T_{UE}_{_{—}}_{SKEW}, the data transmission module 222 may forward the request, to the RNC 102 through the Node B 104, for retransmitting the missing data packet.

In one implementation, the T_{UE}_{_{—}}_{SKEW} is determined by the UESTCM 120. In said implementation, the UESTCM 120 is configured to obtain the maximum skew time for the communication network, as indicated by T_{MAX}_{_{—}}_{SKEW}, from the RNC 102. The T_{MAX}_{_{—}}_{SKEW} is usually based on radio channel conditions expected at a particular geographical region, deployment characteristics of the Node Bs 104 covering the particular geographical area, also referred to as a cell. In context of the present subject matter, cell may be understood as a geographical area served by the Node B 104 or as the smallest coverage area of the Node B 104.

The UESTCM 120 is further configured to determine the probability of a data packet being delayed, henceforth referred to as P_{SKEW}, during transmission based on various network parameters, such as the signal to noise and interference ratio (SNIR), strength of the signal, channel quality index (CQI). On the basis of the obtained T_{MAX}_{_{—}}_{SKEW} and the determined P_{SKEW}, the UESTCM 120 computes the T_{UE}_{_{—}}_{SKEW}. As mentioned earlier, in one implementation, the UESTCM 120 is configured to determine T_{UE}_{_{—}}_{SKEW} based on the equation 1 which is reproduced below

T_{UE}_{_{—}}_{SKEW}=F(P_{SKEW})×T_{MAX}_{_{—}}_{SKEW}+K (Equation 1)

In equation 1 F (P_{SKEW}) denotes any function of P_{SKEW} and K denotes any mathematical constant. The UESTCM 120 may also determine T_{UE}_{_{—}}_{SKEW} based on other network parameters as described later in the description.

As mentioned earlier, on receiving the data packets transmitted by the Node B 104, the data transmission module 222 sends various status information signals informing about the received data packets to the RNC 102 through the Node B 104. The data acknowledgement module 208 of the RNC 102 receives and analyzes the status information signals so as to identify if the status information signals indicate a gap in the order of the received data packets by the UE 110. On identifying a gap in the received data packets by the UE 110, the data acknowledgement module 208 triggers the RNC timer module 206. The RNC timer module 206 waits for a time interval, denoted by T_{RNC}_{_{—}}_{SKEW}, before triggering the RNC control module 210 to retransmission of the missing data packet as indicated by the status transmission signals. For example, on the RNC timer module 206 exceeding T_{RNC}_{_{—}}_{SKEW}, the RNC control module 210 transmits the missing data packet to the UE 110 through the Node B 104.

In one implementation, the T_{RNC}_{_{—}}_{SKEW} is determined by the RNCSTCM 112. In said implementation, the RNCSTCM 112 is configured to determine the probability of a data packet being delayed, i.e. P_{SKEW}, during transmission based on various network parameters, such as the signal to noise and interference ratio (SNIR), strength of the signal, channel quality index (CQI). On the basis of the T_{MAX}_{_{—}}_{SKEW} and the determined P_{SKEW}, the RNCSTCM 120 computes the T_{UE}_{_{—}}_{SKEW}, which, in one implementation, may be computed based on the equation 1 which is reproduced here for convenience.

T_{UE}_{_{—}}_{SKEW}=F(P_{SKEW})×T_{MAX}_{_{—}}_{SKEW}+K (Equation 1)

It should be appreciated that the T_{RNC}_{_{—}}_{SKEW} and the T_{UE}_{_{—}}_{SKEW}, collectively referred to as the T_{SKEW}, are analogous and may be computed using the same or similar techniques based on same or similar network parameters. As mentioned earlier, the T_{RNC}_{_{—}}_{SKEW} and the T_{UE}_{_{—}}_{SKEW} are computed based on the P_{SKEW}. Various techniques for computation of the P_{SKEW} are described herein. It should also be noted that a described technique for computation of the P_{SKEW}, unless explicitly stated, would be applicable for computation of both the T_{RNC}_{_{—}}_{SKEW} and the T_{UE}_{_{—}}_{SKEW}.

In one embodiment, the P_{SKEW} is generated at any of the lower layers of the communication network. If the P_{SKEW} is below a pre-defined threshold value, the same is communicated to a radio link control (RLC) layer. For example, in one implementation if the P_{SKEW} is being determined at the UE 110, the lower layers, i.e., a UE physical layer 236 or a media access control (MAC) layer 234, and if the P_{SKEW} is below the pre-defined threshold, the P_{SKEW} is communicated to the UE RLC layer 232. In another implementation, the P_{SKEW} may be generated at a Node B L1 layer 230 or a Node B L2 layer 228 and on the P_{SKEW} being below the pre-defined threshold, the P_{SKEW} is communicated to a RLC layer 226. In both the implementations the pre-defined threshold may be set to a high value indicating that the missing data packets have a very high probability of being lost during transmission. Further, in said implementations, P_{SKEW} may still be computed even after either or both the RNC timer module 206 and the UE timer module 220 have been triggered. If at any stage, the P_{SKEW} is determined to be below the pre-defined threshold, the RNC timer module 206 or the UE timer module 220 may be interrupted and a request for retransmission of the missing data packets may be sent to the RNC 102 or the RNC 102 may initiate the retransmission of the missing data packets. In said embodiment, the RNC 102 or the UE 110 or both the RNC 102 and the UE 110 may monitor the network parameters associated with the communication network at regular intervals and on the probability of a missing data packet being lost being high, the UE 110 or the RNC 102 may initiate the process of retransmission of the missing data packet, thus reducing the delay that may be caused due to T_{SKEW}.

In another embodiment, the Node B 104 is configured to determine the P_{SKEW} and the same is transmitted to either the UE 110 or the RNC 102 or both the RNC 102 and the UE 110 only when requested. Transmitting the P_{SKEW} only when requested saves on the processing power which may be consumed to determine the P_{SKEW}.

In yet another embodiment, the Node B 104 may be configured to transmit the P_{SKEW} to the RLC layer 226. In another implementation, the MAC layer 224 or the UE physical layer 236 of the UE 110 may transmit the P_{SKEW} to the UE RLC layer 232 of the UE 110 at regular intervals of time. Thus the updated value of the P_{SKEW} is available with the RLC layer 226 or the UE RLC layer 232 making it convenient for determining if a missing data packet is lost during transmission or is delayed.

In an exemplary implementation of the present subject matter, the P_{SKEW} determined by the UE 110 may be based in part on various network parameters such as the radio link condition of the Node Bs 104. In one implementation, the lower layers of the UE 110 such as the physical layer 236 or the MAC layer 234 may determine the P_{SKEW} and transmit the same to the UE RLC layer 232. In another implementation, the UE RLC layer 232 may determine the P_{SKEW} based on the inputs provided by the physical layer 236 or the MAC layer 234. In said implementations, the radio link condition of the Node Bs 104 may be determined on various network parameters such as the signal to noise & interference ratio (SNIR), the signal strength, and the channel quality index (CQI).

In another example, the P_{SKEW} may be a function of the radio link condition of the Node Bs 104. Generally the downlink condition of the radio link is based on the measurements made by the UE 110. The measurements made by the UE 110 is usually transmitted to the RNC 102 using radio resource control (RRC) status messages, which is either very slow or is not updated at regular interval of time. In said implementation, the Node B 104 obtains reports indicative of the CQI from the UE 110 and based on the reported CQI, the Node B 104 may either compute the P_{SKEW} based on the reported CQI or transmit the reported CQI to the RNC 102 so that the RNC 102 may determine the P_{SKEW}.

In yet another implementation, the P_{SKEW} is determined based on the hybrid automatic repeat request (HARQ) status or the sequence number of the last acknowledged data packet, hence forth referred to as LSN. As mentioned earlier the data 114 may be split into a number of data packets and each of these data packets may be carried by a different lower layer packet, i.e., packets of the high speed downlink shared channel (HS-DSCH). Further a number of data packets may be concatenated and transmitted by a single HS-DSCH packet. A data packet having a lower sequence number than the LSN may be delayed due to HARQ retransmissions at the lower layers for example at the HS-DSCH packets. In said implementations, the HARQ retransmission status pertaining to the missing data packets may be used in combination to determine the P_{SKEW}. In one implementation, the lower layers running the HARQ processes may be configured to transmit the HARQ status of the HS-DSCH packets pertaining to the missing data packets to the UE RLC layer 232. In another example, the Node B 104 may be configured to send the HARQ retransmission status to the RNC 102 either at regular intervals of time or when requested by the RNC 102.

In another embodiment, the P_{SKEW} is determined by the Node B control module 218 of the Node B 104. Since the Node B control module 218 may also be configured to assign priority to the data packets, it follows that the Node B control module 218 is aware of that the higher priority data packets may pre-empt the relatively lower priority data packets. Thus, taking into consideration the assigned priorities, the Node B control module 218 may generate a higher value for the P_{SKEW} for the lower priority data packets.

In another example, the reason for a data packet being delayed may also be communicated to the RLC layer 226 or the UE RLC layer 232. The reason for a data packet being delayed may include but is not limited a data packet undergoing HARQ retransmission or a data packet pre-empted by other high priority data packets, etc. Based on the reason the RNC 102 or the UE 110 or both the RNC 102 and the UE 110 may be configured to determine the P_{SKEW} differently, i.e., the network parameters to be taken into consideration for the determination of the P_{SKEW} may be different. Further the Node B 104 may also be configured to transmit the P_{SKEW} or the network parameters to be considered for the computation of the F_{SKEW} to the UE RLC layer 232.

Further any combination of the various network parameters considered for the computation of the P_{SKEW} may be used by the RNC 102 or the UE 110 to compute the P_{SKEW} Moreover, a weightage index, indicative of the weightage of the network parameter, may be assigned to the network parameter so as to determine the P_{SKEW} The computation of P_{SKEW}, the operation of the RNC 102 and the UE 110 is further described in conjunction with FIG. 2 (b).

FIG. 2 (b) illustrates an exemplary data flow diagram, in accordance with an embodiment of the present subject matter. At the RNC 102, block 252 depicts data, also referred to as the radio link control protocol data unit (RLC PDU), which is to be transferred to the UE 110. The RLC PDU comprises of a number, in this example eight, of data packets. The data packets are denoted as having sequence number R1, R2, R3, R4, R5, R6, R7, and R8. In said example, the RNC 102 splits the data packets between the Node B 104-1 and the Node B 104-2. For example, the data packets having sequence numbers R1, R3, R5, R7, as depicted by block 254-1, are transmitted by the RNC control module 210 to the Node B 104-1 and the data packets having sequence numbers R2, R4, R6, R8, as depicted by block 254-2 are transmitted to the Node B 102-2. The data packets as received by the Node Bs 104 may be further segmented and/or concatenated into HS-DSCH packets, depicted by blocks, located between lines marked 260 and 262, marked H1, H2, H3, H4, H5, H6 for the Node B 104-1 and by the blocks, located between the lines marked 260 and 262, marked H7, H8, H9, H10, H11 for the Node B 104-2.

The UE 110 is configured to send reports indicative of the CQI through HS-DPCCH messages to the Nodes Bs 104-1 and 104-2. In one implementation, the Node Bs 104-1 and 104-2 are configured to associate a CQI value with each of the HS-DSCH packets. As shown in the FIG. 2 (b), the transmitted CQI values are depicted by blocks, located below line marked 262, marked as P1, P2, P3, P4, P5, P6 for the HS-DSCH packets transmitted from the Node B 104-1 and by blocks, located below line marked 262, marked S1, S2, S3, S4, S5 for the HS-DSCH packets transmitted from the Node B 104-2.

The data received by the UE 110 is depicted by block 264. As shown in the FIG. 2(b), the data packet receiver module 219 may detect a gap in the received data packets due to the missing data packet having the sequence number R5. Based on the detection, the data transmission module 222 may generate and transmit status information signals informing the RNC 102 of the missing data packet. In one implementation, the RNC 102 may request the Node B 104-1 for the P_{SKEW} associated with the missing data packet R5. In another implementation, the Node B 104-1 may be configured to transmit the P_{SKEW} value to the RNC 102 based on pre-defined criterion such as the radio link for a particular data packet falling below a pre-defined threshold.

In said implementation, for each HS-DSCH packets related to the missing data packet, i.e., the data packet having sequence number R5, the Node B 104-1 is configured to determine the CQI. In this example, for each of the associated HS-DSCH packets, i.e., HS-DSCH packets indicated by H2, H3, H4, the Node B 104-1 determines the CQI required to support the packet sizes of the HS-DSCH packets H2, H3 and H4. In this example, it is assumed for the sake of explanation that the required CQI is C2, C3 and C4 for the HS-DSCH packet H2, H3, and H4 respectively. The Node B 104-1 is further configured to determine the difference between the required CQI and the reported CQI, as indicated by blocks marked P2, P3 and P4, for the HS-DSCH packet H2, H3 and H4. Table 1 shows exemplary values for the same.

TABLE 1

| | | | | | Difference in CQI |
|---|---|---|---|---|---|
| HS-DSCH | Reported CQI | | Required CQI | | (ΔCQI) |
| Packet | Label | Value | Label | Value | Value |
| H2 | P2 | 6 | C2 | 15 | −9 |
| H3 | P3 | 5 | C3 | 16 | −11 |
| H4 | P4 | 6 | C4 | 14 | −8 |

In said implementation, the difference between the required CQI and the reported CQI, represented by ΔCQI, is transmitted by the Node B 104-1 to values the RNC 102. It would be apparent from the above description that a positive value of ΔCQI would indicate that the HS-DSCH packet was sent when the condition of the radio channel was better than what is requires whereas a negative value of the ΔCQI would indicate that the conditions of the radio channel were poorer than what is required to transmit the HS-DSCH packet. In one example, the P_{SKEW} of the HS^{—}DSCH packet would be based on the ΔCQI. An exemplary relation between the P_{SKEW} and the ΔCQI may be in accordance with equation 2.

$${P}_{SKEW} = \{ \begin{matrix}0 , & Δ CQI < - 10 \\ \frac{10 + Δ CQI}{10} , & - 10 \leq Δ CQI \leq 0 \\ 1 , & Δ CQI > 0\end{matrix} . \qquad Equation 2$$

As would be indicated in the equation 2, if the ΔCQI is less than a specified value, −10 in the above example, then the HS-DSCH packet is deemed to be lost. Using the exemplary values depicted in Table 1, the Node B 104-1 may determine the P_{SKEW} in accordance with the equation 2. Table 2 depicts the value of the determined P_{SKEW} for each of the HS-DSCH packets H2, H3 and H4.

TABLE 2

| HS-DSCH Packet | Δ CQI | P_{SKEW} |
|---|---|---|
| H2 | −9 | 0.1 |
| H3 | −11 | 0 |
| H4 | −8 | 0.2 |
| Minimum P_{SKEW} (for Data Packet | Not Applicable | 0 |
| having sequence number R5) | | |

It would be apparent that if any of the HS-DSCH packets, H2, H3 and H4 would be lost, the data packet having the sequence number R5 would not be received by the UE 110. In one implementation, the Node B 104-1 is configured to select the minimum P_{SKEW} of the HS-DSCH packets, H2, H3 and H4 as the P_{SKEW} of the data packet having the sequence number R5, in this example 0. Hence in the above example, the data packet having the sequence number R5 is deemed to be lost and the RNC 102 initiates the retransmission of the data packet having the sequence number R5.

In another example, the UE 110 is configured to transmit the report indicative of the CQI report using the HS-DPCCH messages to the Node Bs 104-1 and 104-2. In this example, the data packet having the sequence number R4 is detected to be missing by the UE 110. Using techniques described above the RNC 102 obtains the minimum ΔCQI for the HS-DSCH packet, i.e., H10, corresponding the data packet having sequence number R4 from the Node B 104-2. In said example, the Node B 104-2 determines the ΔCQI value to be 1 and sends this value to the RNC 102. Further, the Node B 104-2 also transmits the HARQ status for the HS-DSCH packet H10 to the RNC 102. The RNC 102 may first determine the condition of the radio channel for the HS-DSCH packet H10 based on the ΔCQI. As a value of 1 for ΔCQI indicates that the condition of the radio channel is good, the RNC 102 may obtain the HARQ status of the HS-DSCH packet H10. If the RNC 102 determines that the HS-DSCH packet H10 is in the process of HARQ retransmission, the RNC 102 may assign a high value to the P_{SKEW} of the missing data packet, i.e., the data packet having sequence number R4 and initiate the RNC timer module 206 to wait for the data packet having sequence number R4 to be acknowledged by the UE 110.

Yet in another example, the P_{SKEW} may be based on the conditions of the radio channel averaged over all the data packets and the HARQ status, instead of a specific data packet, i.e., the data packet which is missing. The P_{SKEW}, which is based on averaged conditions of the radio channel, may be used for updating the RNC 102 at regular intervals.

The average value of the ΔCQI is henceforth referred to as the CQI_{AVERAGE} and a P_{SKEW} computed based on the CQI_{AVERAGE}, for example by using techniques described above is denoted as P_{SKEW}(CQI_{AVERAGE}). It is also apparent to those skilled in the art that the HARQ status is also indicative of the radio channel conditions, i.e., a higher number of HARQ retransmissions indicate poor condition of the radio channel and vice-versa. An exemplary relation between the P_{SKEW} and the number of HARQ retransmissions, indicated by N_{HARQ}, is illustrated using equation 3.

$${P}_{SKEW} = 1 - \frac{{N}_{HARQ}}{{N}_{MAX\_HARQ}} \qquad Equation 3$$

In the equation 3, N_{MAX}_{_{—}}_{HARQ} is the maximum number of HARQ transmissions allowed by the RNC 102 and is pre-defined by a service provider of the communication network. An average P_{SKEW} may also be based on the N_{HARQ} averaged over a number of data packets and is denoted by P_{SKEW}(HARQ). In one example, the overall P_{SKEW} may be computed based on equation 4.

P_{SKEW}=W₁P_{SKEW}(CQI_{AVERAGE})+W₂P_{SKEW}(HARQ) Equation 4

In equation 4, W₁ and W₂ are weightage indices indicative of the importance or priority of each network parameter. Further, in one example, the weightage indices may be fractions such that the summation of all weightage indices equals to unity. The overall value of the P_{SKEW} thus determined may be periodically sent to the RNC 102 or the UE 110 so as to determine the T_{RNC}_{_{—}}_{SKEW} or the T_{UESKEW}.

Further as mentioned earlier, any data packet which is in the data buffer unit 214 of the Node B 104 for a time period exceeding T_{Discarded} is removed and thus is lost. Hence the P_{SKEW} for a data packet is also based on the time, indicated by T_{STORE} for which a data packet is stored in the data buffer unit 214. On the T_{STORE} becoming equal to the value of the T_{Discarded}, the data packet is removed. An exemplary technique to determine P_{SKEW}, represented as P_{SKEW}(T_{STORE}), based on the T_{STORE} is illustrated using equation 5.

$${P}_{SKEW} ( {T}_{STORE} ) = 1 - \frac{{T}_{STORE}}{{T}_{Discarded}} \qquad Equation 5$$

Further, a weightage index, W₃, may be assigned to the P_{SKEW}(T_{STORE}) and an overall value of P_{SKEW} may be determined based on equation 6. In one implementation, the weightage parameters may be assigned based on various factors such as priority of data packets stored in the data buffer unit 214 of the Node B 104.

P_{SKEW}=W₁P_{SKEW}(CQI_{AVERAGE})+W₂P_{SKEW}(HARQ)+W₃P_{SKEW}(T_{STORE}) Equation 6

It should be appreciated by those skilled in the art that the above described techniques of determining the P_{SKEW} are provided as an example and are not exhaustive. A person skilled in the art may configure the determination of the P_{SKEW} based on other network parameters associated with the communication network and the same may be considered to be within the scope of the present subject matter.

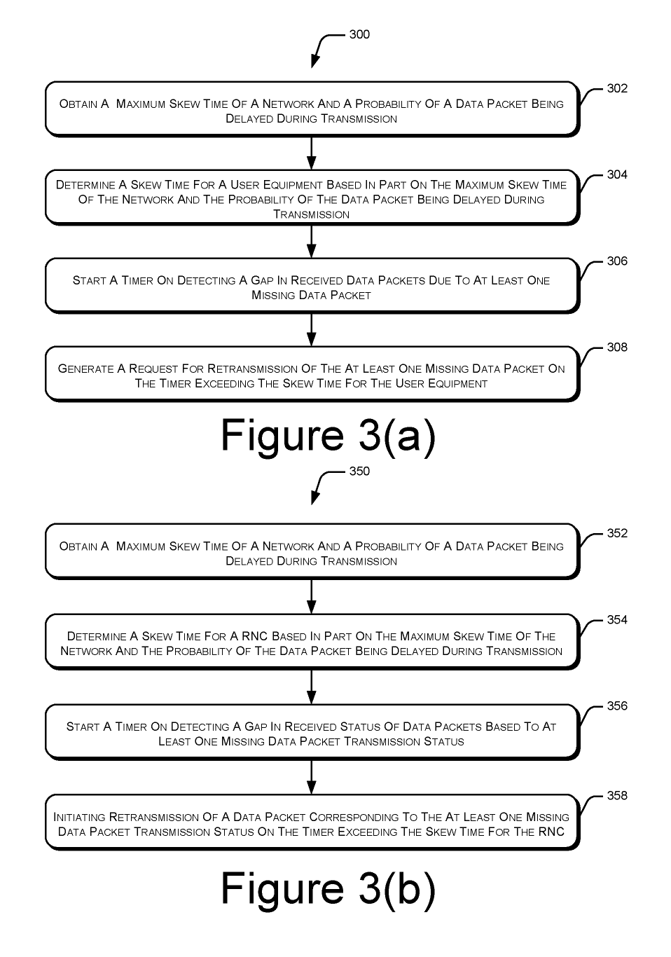

FIG. 3(a) illustrates an exemplary method 300 for data transfer in a communication network, in accordance with an embodiment of the present subject matter, and FIG. 3(b) illustrates an exemplary method 350 for data transfer in a communication network, in accordance with another embodiment of the present subject matter. The order in which the methods 300 and 350 are described is not intended to be construed as a limitation, and any number of the described method blocks can be combined in any order to implement the methods 300 and 350, or an alternative method. Additionally, individual blocks may be deleted from the methods 300 and 350 without departing from the spirit and scope of the subject matter described herein. Furthermore, the methods 300 and 350 may be implemented in any suitable hardware, software, firmware, or combination thereof.

A person skilled in the art will readily recognize that steps of the methods 300 and 350 can be performed by programmed computers. Herein, some embodiments are also intended to cover program storage devices, for example, digital data storage media, which are machine or computer readable and encode machine-executable or computer-executable programs of instructions, where said instructions perform some or all of the steps of the described methods 300 and 350. The program storage devices may be, for example, digital memories, magnetic storage media such as a magnetic disks and magnetic tapes, hard drives, or optically readable digital data storage media. The embodiments are also intended to cover both communication network and communication devices configured to perform said steps of the exemplary methods 300 and 350.

With reference to method 300 as depicted in FIG. 3(a), as illustrated in block 302, a user equipment, such as the UE 110, is configured to obtain a maximum skew time of a communication network and a probability index, for example the P_{SKEW}, indicative of a probability of a data packet being delayed, i.e., skewed, during transmission over the communication network. In one implementation, the UE 110 may be configured to compute the value of P_{SKEW} whereas in another embodiment, the P_{SKEW} may be requested and obtained from the Node B 104 or from the RNC 102 through the Node B 104.

At block 304, a skew time is determined for the UE 110 based on the maximum skew time of the communication network and the probability index, for example the P_{SKEW}. As mentioned earlier, the P_{SKEW} is indicative of the probability of a data packet being delayed, i.e., skewed, during transmission over the communication network. In one example, the UESTCM 120 is configured to determine the UE skew time, i.e., the T_{UE}_{_{—}}_{SKEW}, based in part on the T_{MAX}_{_{—}}_{SKEW} and the P_{SKEW}.

As illustrated in block 306, a timer is started on detecting a gap in the received data packets by the UE 110. The gap is usually caused due to one or more missing packets. In one implementation, the data packet receiver module 219 of the UE 110 is configured to determine a gap in the sequence of the received data packets. On detecting a gap in the sequence of data packets, the data packet receiver module 219 may be configured to trigger the UE timer module 220.

As depicted in block 308, a request for retransmission of the missing data packets is generated on the timer exceeding the determined skew time. In one implementation, on the UE timer module 220 exceeding the T_{UE}_{_{—}}_{SKEW}, the data transmission module 222 is configured to generate a request for the RNC 102 to retransmit the missing data packets.

With reference to method 350 as depicted in FIG. 3(b), as illustrated in block 352, a radio network controller, such as the RNC 102, is configured to obtain a maximum skew time of a communication network and a probability index, for example the P_{SKEW}, indicative of a probability of a data packet being delayed, i.e., skewed, during transmission over the communication network. In one implementation, the RNC 102 may be configured to compute the value of P_{SKEW} whereas in another embodiment, the P_{SKEW} may be requested and obtained from the Node B 104 or from the UE 110 through the Node B 104.

At block 354, a skew time is determined for the RNC 102. The determined skew time may based on the maximum skew time defined for the communication network and the probability index, for example the P_{SKEW}, indicative of the probability of a data packet being delayed, i.e., skewed, during transmission over the communication network. In one example, the RNCSTCM 112 is configured to determine the RNC skew time, i.e., the T_{RNC}_{_{—}}_{SKEW}, based in part on the T_{MAX}_{_{—}}_{SKEW} and the P_{SKEW}.

As illustrated in block 356, a timer is started on detecting a gap in the received status of the data packets by the UE 110, based on the status information signals indicating one or more missing data packets. In one implementation, the data acknowledgement module 208 of the RNC 102 may be configured to determine a gap in the sequence of the data packets, as received by the UE 110, based on the status information signals received from the UE 110. On detecting a gap in the sequence of data packets as received by the UE 110, the data acknowledgement module 208 may be configured to trigger the RNC timer module 206.

As depicted in block 358, retransmission of the missing data packets is initiated on the timer exceeding the determined skew time. In one implementation, on the RNC timer module 206 exceeding the T_{RNC}_{_{—}}_{SKEW}, the RNC control module 210 is configured to initiate the process of retransmitting the missing data packets to the UE 110 through the Node B 104.

Although implementations for data transfer in a communication network have been described in language specific to structural features and/or methods, it is to be understood that the appended claims are not necessarily limited to the specific features or methods described. Rather, the specific features and methods are disclosed as exemplary implementations for data transfer in a communication network.

1. A method for data transfer in a communication network, the method comprising:
obtaining a probability of a data packet being delayed during transmission over the communication network based in part on at least one network parameter;
assigning a weightage index to the at least one network parameter, wherein the assigned weightage index is indicative of the importance of the at least one network parameter;
determining a skew time based in part on a maximum skew time of the communication network and the probability of the data packet being delayed during transmission;
detecting at least one missing data packet transmission; and
on detecting the at least one missing data packet transmission, initiating retransmission of the at least one missing data packet after a time interval exceeding the determined skew time.

2. (canceled)

3. The method as claimed in claim 1, wherein the at least one network parameter comprises one of a channel quality index, status of at least one hybrid automatic repeat transmission, number of HARQ retransmissions and a maximum time interval for which the data packet is stored in a buffer of a Node B, assigned priority of the data packet, and assigned priority of at least another data packet.

4. The method as claimed in claim 1, wherein the method further comprises determining the value of the at least one network parameter based in part on averaging a value of the at least one network parameter for each of a plurality of data packets.

5. The method as claimed in claim 1, wherein a value of the at least one network parameter is associated with the at least one missing data packet.

6. A radio network controller comprising:
a RNC skew time computation module configured to obtain a skew time based in part on a maximum skew time of a communication network and a probability of a data packet being delayed during transmission, wherein the RNCSTCM is further configured to determine the probability of the data packet being delayed during transmission based in part of at least one network parameter, and wherein the RNCSTCM is further configured to assign a weightage index to the at least one network parameter, and wherein the assigned weightage index is indicative of the importance of the at least one network parameter;
a data acknowledgement module configured to identify at least one gap in the sequence of received data packets, the gap resulting because of at least one missing data packet; and
a RNC timer module configured to initiate retransmission of the at least one missing data packet after a time interval exceeding the determined skew time, on identifying the at least one gap.

7. (canceled)

8. The RNC as claimed in claim 6, wherein the RNC further comprises a RNC control module configured to obtain at least one of the skew time and the probability of the data packet being delayed during transmission from at least one Node B.

9. The RNC as claimed in claim 8, wherein the RNC control module is further configured to obtain the priority of transmission of the at least one data packet from the at least one Node B.

10. (canceled)

11. The RNC as claimed in claim 10, wherein the at least one network parameter comprises one of a channel quality index, status of at least one hybrid automatic repeat transmission, number of HARQ retransmissions and a maximum time interval for which the data packet is stored in a buffer of a Node B, assigned priority of the data packet, and assigned priority of at least another data packet.

12. The RNC as claimed in claim 10, wherein the determination of the value of the at least one network parameter based in part on averaging a value of the at least one network parameter for each of a plurality of data packets.

13. A user equipment comprising:
a UE skew time computation module configured to determine a skew time based in part on a maximum skew time of a communication network and a probability of a data packet being delayed during transmission, wherein the UESTCM is further configured to compute the probability based in part of at least one network parameter, and wherein the UESTCM is further configured to assign a weightage index to the at least one network parameter, and wherein the assigned weightage index is indicative of the importance of the at least one network parameter;
a data packet receiver module configured to identify at least one gap in the sequence of received data packets, the gap resulting because of at least one missing data packet; and
a UE timer module configured to generate a request for retransmission of at least one missing data packet on exceeding the determined skew time.

14. The user equipment as claimed in claim 13, wherein the data packet receiver module is further configured to obtain at least one of the maximum skew time and the probability from at least one of a radio network controller and a Node B.

15. (canceled)

16. (canceled)

17. A computer-readable medium having embodied thereon a computer program for executing a method comprising:
obtaining a probability of a data packet being delayed during transmission over the communication network based in part on at least one network parameter;
assigning a weightage index to the at least one network parameter, wherein the assigned weightage index is indicative of the importance of the at least one network parameter;
determining a skew time based in part on a maximum skew time of the communication network and the probability of the data packet being delayed during transmission.

18. (canceled)

19. (canceled)

20. The computer-readable medium as claimed in claim 17, wherein the at least one network parameter includes a channel quality index, status of at least one hybrid automatic repeat transmission, number of HARQ retransmissions and a maximum time interval for which the data packet is stored in a buffer of a Node B, assigned priority of the data packet, assigned priority of at least another data packet.
